(19) United States
(12) Patent Application Publication
(10) Pub. No.: US 2014/0022170 A1
(43) Pub. Date: Jan. 23, 2014

(54) LIGHT CURTAIN AND AN INPUT APPARATUS BASED THEREON FOR A DATA PROCESSING SYSTEM

(71) Applicant: Robert Koeppe, Linz (AT)

(72) Inventor: Robert Koeppe, Linz (AT)

(73) Assignee: ISIQIRI INTERFACE TECHNOLOGIES GMBH, Hagenberg (AT)

(21) Appl. No.: 14/002,813

(22) PCT Filed: Feb. 9, 2012
(86) PCT No.: PCT/AT2012/000022

§ 371 Date: Sep. 3, 2013

(30) Foreign Application Priority Data
Mar. 4, 2011 (AT) A 289/2011

(51) Int. Cl. G06F 3/042

(52) U.S. Cl. CPC G06F 3/0421
USPC 345/157; 250/221; 250/458.1

(57) ABSTRACT

A light curtain having a light source which emits a light beam which propagates in an area to be monitored by the light curtain and then strikes an optical detector surface. The area to be monitored is arranged in the vicinity of a translucent disc and is oriented parallel to the latter. The light source and detector surface are arranged on that side of the disc which faces away from the area to be monitored. The path of the light beam from the light source to the detector surface runs twice through the plane of the disc and via two mirrors arranged on the edge of the area to be monitored.

The invention relates to a light curtain and an input apparatus based thereon for a data processing system.

A light curtain within the meaning of this description is an optical monitoring device in which the principle of the light barrier is extended from a linear monitoring region to an areal monitoring region.

In the simplest case, light curtains are formed by stringing together light barriers oriented parallel to one another. For reliable detection of an object and also for good detection of its position in the monitored area, a large number of light sensors and light sources are required. In some cases, light sources are used in which the cross-sectional area of the emitted light beam has approximately the form of a straight line. By virtue of this line being oriented parallel to the orientation of the series formed by stringing together light sensors, a smaller number of light sources than light sensors may suffice.

AT 507267 A1 and AT 507702 A2 describe optical detector surfaces and applications therefor as control surfaces for data processing systems. In this case, the optical detector surfaces are constructed from one or a plurality of planar optical waveguides, to each of which is fitted at least one photoelectric sensor having a very small area by comparison therewith, wherein a layer of the optical waveguide has photoluminescent properties. The radiation of a light spot impinging on the detector surface is converted by photoluminescence into longer-wave light which propagates in the planar optical waveguide, in the process is attenuated with increasing distance from the light spot and is coupled out from the optical waveguide at the photoelectric sensors and detected.

Detector surfaces of this type can be flexible and maneuverable, are cost-effective per area and are well suited to fast signal processing of light signals. By taking account of the attenuation of the light signal propagating in the waveguide, using mathematical evaluation methods, a good spatial resolution when ascertaining the impingement location of a light spot is possible even in the case of large detector surfaces with few tapping points.

AT 508 135 B1 describes a planar detector which is intended for application on light curtains and which is formed as a flexible layer construction composed of organic material and generates electrical signals depending on absorbed light. The detector is provided with a plurality of tapping points for the signals generated, wherein the magnitude of the signals at the individual tapping points is dependant on the distance thereof from the partial areas at which the light is absorbed, and wherein the distance ratios of the respective tapping points relative to those partial areas at which the light is absorbed can be calculated from the size ratios between the signals at a plurality of tapping points. A plurality of application variants for light curtains equipped with such a detector are disclosed.

DE 2550653 B2, inter alia, describes a light curtain for monitoring a space, wherein an individual, so-called rotary light source is used. In this case, a light beam is emitted from an individual light source, although the light source—or a mirror illuminated by the light source—is rotated, such that the light beam passes through an area of the space with a specific cyclic timing. On the strips of the walls on which the light beam impinges, if no shading object is situated in the space, the walls are provided with reflectors, namely with reversal reflectors or plane mirrors, such that the light beam is reflected back either directly or indirectly for instance to the light source. A light sensor is also situated in the vicinity of the light source.

DE 197 23 974 A1 discloses the principle described with reference to DE 2550653 B2 for example monitoring the window opening in a motor vehicle door, in order to prevent an object from being trapped by the motor-drivable sliding window.

The problem addressed by the invention is to provide a principle of action for a light curtain according to which in two dimensions within an area to be monitored the fact of the presence of an object, and the size and position of the object can be ascertained in real time, wherein the area to be monitored is intended to be arranged in the vicinity of and parallel to a light-transmissive sheet. By comparison with known principles for realization of light curtains suitable for this purpose, the intention is to be able to realize light curtains which function more robustly under economic boundary conditions with the principle of action that is to be newly provided.

According to the new principle, by way of example, the intention is to be able to realize touch-sensitive input surfaces (touchscreen) for data processing systems or it is intended thereby to be possible to detect in a spatially resolving manner the approach of objects from outside to a window pane, such as typically to a display window.

The problem is solved proceeding from a design in which from one or a plurality of light sources light is sent along the area to be monitored, the arrival of light is detected at edge regions of the area to be monitored and, in the case of light not arriving, the location and size of a shading object penetrating through the area to be monitored are deduced by means of geometrical calculations. The invention proposes arranging light source(s) and detector surface(s) at that side of the sheet which faces away from the area to be monitored, passing the light required for the function of the light curtain through the sheet twice and for this purpose, at that side of the sheet at which the area to be monitored is situated, fitting mirrors on edges of the area to be monitored.

The invention is illustrated with reference to a drawing:

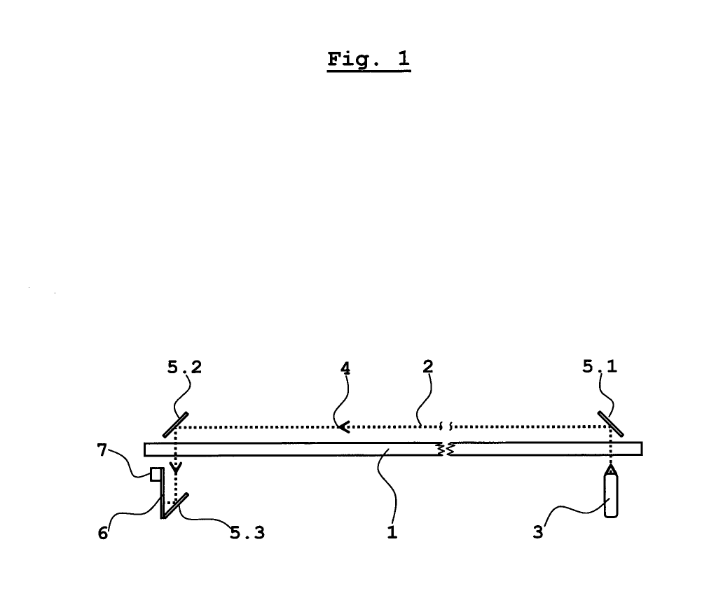

FIG. 1 shows a basic schematic diagram of the parts essential for understanding the invention, in a view in which the viewing direction is parallel to the area 2 to be monitored.

In the example in accordance with FIG. 1, the area 2 to be monitored is arranged above the sheet 1 and parallel thereto.

The light source 3 is typically a laser with line optics, that is to say a laser which emits a light beam 4 whose cross-sectional area is a line. The plane in which the light beam 4 propagates after the emergence thereof from the light source 3 is normal to the plane of the sheet 1. The light beam 4 penetrates through the sheet 1, and passes to the mirror 5.1 at the side facing away from the light source 3, the plane of which mirror is inclined by 45° with respect to the plane of the sheet and which mirror delimits the area 2 to be monitored at one edge. The light beam 4 is reflected at the mirror 5.1, with the result that it propagates parallel to the plane of the sheet 1. The area which it now covers is the area 2 to be monitored.

At a next mirror 5.2, which is likewise inclined by 45° with respect to the sheet and delimits the area 2 to be monitored at a further edge, the light beam 4 is deflected again, with the result that it now passes through the sheet 1 a second time in an opposite direction. Via a third mirror 5.3, the light beam finally passes to an optical detector surface 6 embodied as a strip, is absorbed there and, at tapping points 7, which are arranged at a distance from one another on the detector surface, causes in each case an electrical signal, the magnitude of which is dependant on the distance between the respective tapping point and the point of impingement of a light pulse on the detector surface. The signals from the tapping points 7 are conducted to an evaluating controller (not illustrated).

When a shading object, such as typically a pen or a finger, projects through the area 2 to be monitored to the sheet 1, then a part of the cross-sectional area of the light beam 4 is shaded and then no light passes to a longitudinal region of the detector surface 6 which was previously still illuminated. The measured electrical signal decreases at the tapping points 7 near said longitudinal region and the position of the shading object in the area 2 to be monitored can be deduced by the evaluating controller.

By virtue of the design according to the invention, all the electronic components can be arranged at one side of the sheet 1. There is also no need for electrical lines to be led to the side of the sheet 1 at which the area to be monitored is situated. Only the mirror strips 5.1, 5.2 need to be mounted at the side of the area to be monitored.

What is advantageous about this arrangement becomes clear from consideration of the application of the light curtain on a display window. In this case, the sheet 1 is the display window pane. No electronic parts or electrical lines whatsoever need to be arranged in the exterior region. It suffices to arrange mirror strips 5.1, 5.2 in the exterior region. In the case of vandalism, it is merely necessary to exchange or clean a mirror. There is no need to design electrical parts with regard to particular weather influences. Furthermore, it is not necessary to lay any supply or data cables into the exterior region. It thus becomes readily possible to realize an “interactive display window” that is a display window in which settings that relate to on the interior region can be altered by an observer from outside by passing the hand over the sheet 1. (Said settings might be lighting, shifting objects presented, switching on information films . . . )

In one advantageous embodiment, the detector 6 and the tapping points 7 are realized in accordance with the principle described in the introduction with reference to AT 507267 A1 and AT 507702 A2. Accordingly the detector surface 6 is formed from one or a plurality of planar optical waveguides and the tapping points 7 are photoelectric sensors having a very small area by comparison therewith. A layer of the optical waveguide has photoluminescent properties. The radiation of a light pulse impinging on the detector surface is converted by photoluminescence into light with longer wavelength which propagates in the planar optical waveguide. The intensity of said light with longer wavelength is reducing with increasing distance from the point at which the light pulse is impinging and is coupled out from the optical waveguide at the photoelectric sensors (tapping points 7) and detected.

It is thus possible to realize flexible, maneuverable, robust, cost-effective large-area or very long planar detectors having a high spatial resolution. For the case of application on display windows but also on touchscreens, what is particularly advantageous about this sensor technology is that it is not very sensitive to background light since the detector surface can readily be set to the situation that only light of a specific wavelength triggers luminescence as intended. Good robustness against extraneous light can also be achieved by virtue of the fact that the detection is very fast, as a result of which it is readily possible to modulate the light beam 4 to be detected in terms of its intensity with a specific, high frequency (in the MHz range), and to permit only correspondingly modulated signals to pass through filters to the controller. Precisely in the case of use in a display window, the insensitivity toward background light is very important, since the lighting conditions can change greatly in the course of the day.

Generally, a single light source 3 and a single detector surface 6 will not be used, but rather a plurality of light sources 3 arranged at different positions along the edge of the sheet 1, and also a plurality of detector surfaces 6, ideally as a frame around the sheet. In this regard, in the case of a display window, the expensive glass pane already present generally does not have to be demounted if a light curtain according to the invention is installed subsequently.

It is important that the detection results of the different light sources can be distinguished from one another, for example by different modulation frequencies or by phase-offset pulsating emission of light pulses. The more different light sources are used, the more exactly the location and cross-sectional area of a shading object in the area 2 to be monitored can be localized and the latter, too, a plurality of shading objects present simultaneously can be distinguished from one another.

Of course, as an alternative to applying the luminescence waveguide principle for the optical detection it is also possible to apply other measurement principles.

By way of example, the detector surface 6 can be embodied as an inactive surface, the image of which is captured by a camera—preferably a linear camera. The reflection of the light beam 4 generates a bright line on the detector surface 6, which line can be recognized by the image captured by the camera and can be evaluated by means of data technology. (In this case, the image refresh frequency is currently typically in the kHz range). Shading objects at the area 2 to be monitored cause said line to be interrupted. This can also be carried out in addition to the previously explained measurement principle based on luminescence wave guiding, since a part of the light generated in the luminescence waveguide is coupled out directly again and, consequently, a bright line arises at the impingement location of the light beam.

The mirror 5.3 illustrated in FIG. 1 can be omitted if the detector surface 6 is oriented at least parallel to the sheet 1. The embodiment is thus simpler than the embodiment illustrated, but not as advantageous optically, under certain circumstances.

Instead of embodying the light source 3 as a laser with line optics, it is also possible, of course, to use a rotary light source, that is to say a light source which emits a light beam having an approximately punctiform cross-sectional area, but the direction of the light beam is constantly rotated, such that the light beam repeatedly sweeps through an area.

Particularly for this purpose it is appropriate for the mirror 5.1 to be embodied in a curved fashion and for the light source 3 to be moved such that the light beam continuously sweeps over the entire area. (With the use of a laser with line optics it is also possible, of course, for the mirror 5.1 to be embodied in a curved fashion, in order to intensify the expansion of the light beam in the longitudinal direction of the cross-sectional area of the light beam.)

In the schematic diagram in FIG. 1, the plane of rotation of the light beam 4 would lie at the exit region from the light source 3 vertically normal to the plane of the sheet 1 and would be visible as a line in FIG. 1.

In a further development of the invention, as the object which brings about shading in the area 2 to be monitored, it is also possible to use a device which itself emits light which can be measured by means of the detector surface 6. The light which is emitted by the device is in this case directed by the mirror strip 5.2 onto the detector surface 6 and is detected there. By way of example, this device can be a luminous pen equipped with a light emitting diode pulsating at a predefined characteristic frequency. By virtue of the fact that the evaluating controller can thus recognize that this is not any shading object, but rather a very specific shading device, specific functions can be assigned to this device and to the shading brought about by it. These specific functions may typically be more important authorizations in a data processing system which can be controlled by the light curtain according to the invention as a touchscreen.

1.-6. (canceled)

7. A light curtain comprising:
a light-transmissive sheet that is arranged in the vicinity of the area to be monitored by the light curtain, said area is oriented parallel to said light-transmissive sheet;
a detector surface that is arranged at that side of the sheet which faces away from the area to be monitored;
mirrors that are arranged at two mutually spaced apart edge regions of the area to be monitored at the side of the sheet at which the area to be monitored is also situated, the reflection plane of said mirrors being inclined with respect to the area to be monitored; and
a light source that is arranged at that side of the sheet which faces away from the area to be monitored, said light source emits a light beam which propagates in an area to be monitored by the light curtain and subsequently impinges on the optical detector surface, the path of said light beam from the light source to the detector surface passing twice through the plane of the sheet via the two mirrors.

8. The light curtain as claimed in claim 7, wherein the light source emits a light beam whose cross-sectional area is a line.

9. The light curtain as claimed in claim 7, wherein the detector surface is formed from one or a plurality of planar optical waveguides which are able to convert impinging radiation of the light beam by photoluminescence into longer-wave light which propagates in the planar optical waveguide, tapping points are arranged at the detector surface, said tapping points being formed by photoelectric sensors which generate an electrical signal from the light propagating in the optical waveguide.

10. The light curtain as claimed in claim 7, wherein the sheet is a display window pane.

11. The light curtain as claimed in claim 7, wherein the sheet is the touch surface of a touchscreen.

12. The light curtain as claimed in claim 7, wherein said light curtain is used as input apparatus for a data processing system said data processing system can be influenced depending on the detection result at the detector surface and the input apparatus additionally has a freely movable pointing device which can be recognized by the data processing system by virtue of the pointing device emitting light which can be detected by the detector surface.

13. The light curtain as claimed in claim 7, wherein the light source emits a light beam having an approximately punctiform cross-sectional area and the direction of the light beam is constantly rotated, such that the light beam repeatedly sweeps through an area.

14. The light curtain as claimed in claim 13, comprising at least two of said light sources each light source emitting a light beam with distinctive coding features.

15. The light curtain as claimed in claim 8, comprising at least two of said light sources that are located on positions related to at least two edges of the sheet.

16. The light curtain as claimed in claim 7, wherein two detector surfaces are located on positions related to two edges of the sheet , said edges are arranged at right angles.

17. The light curtain as claimed in claim 7, wherein four detector surfaces are located on positions related to four edges of the sheet.
